(19) United States
(12) Patent Application Publication
(10) Pub. No.: US 2017/0305237 A1
(43) Pub. Date: Oct. 26, 2017

(54) EVAPORATOR AND VEHICULAR AIR CONDITIONER USING THE SAME

(71) Applicant: KEIHIN THERMAL TECHNOLOGY CORPORATION, Oyama-shi (JP)

(72) Inventors: Motoyuki TAKAGI, Oyama-shi (JP); Naohisa HIGASHIYAMA, Oyama-shi (JP); Osamu KAMOSHIDA, Oyama-shi (JP)

(73) Assignee: KEIHIN THERMAL TECHNOLOGY CORPORATION, Oyama-shi (JP)

(21) Appl. No.: 15/479,288

(22) Filed: Apr. 5, 2017

(30) Foreign Application Priority Data
Apr. 21, 2016 (JP) 2016-085140

(51) Int. Cl. B60H 1/32; B60H 1/00

(52) U.S. Cl. CPC B60H 1/3227; B60H 1/005; B60H 2001/00092

(57) ABSTRACT

In an evaporator for a vehicular air conditioner, the core width W is uniform over the entire region in the left-right direction. Further, the widths of all air-passing spaces in the left-right direction are equal to one another, the tube heights Ht of all refrigerant flow tubes are equal to one another, and the fin heights HF of all corrugated fins are equal to one another. The core width W, the tube pitch Tp (the distance between the thicknesswise centers of the refrigerant flow tubes located on the left and right sides of each air-passing space), the tube height Ht, and the fin height Hf are such that W=27 to 32 mm, Tp=4.3 to 5.5 mm, Ht=1.3 to 1.5 mm, Hf=3.0 to 4.0 mm, and Ht/Hf=0.325 to 0.500.

### BACKGROUND OF THE INVENTION

The present invention relates to an evaporator mounted on, for example, an automobile and to a vehicular air conditioner in which the evaporator is used.

In the present specification and appended claims, the upper, lower, left, and right sides as viewed from the downstream side toward the upstream side with respect to the flow direction of air passing through air-passing spaces between adjacent refrigerant flow tubes (a direction represented by arrow X in FIG. 1) (the upper, lower, left, and right sides of FIG. 1) will be referred to as “upper,” “lower,” “left,” and “right,” respectively.

An evaporator which is used for a vehicular air conditioner is known (see Japanese Patent No. 4686062). The known evaporator includes two header tanks disposed apart from each other in the vertical direction such that their longitudinal direction coincides with the left-right direction; and a heat exchange core section provided between the two header tanks. Each of the header tanks includes a leeward header and a windward header whose longitudinal direction coincides with the left-right direction. The heat exchange core section includes a plurality of flat refrigerant flow tubes whose longitudinal direction coincides with the vertical direction, whose width direction coincides with the air-passing direction; and corrugated fins each of which has crest portions extending in the air-passing direction, trough portions extending in the air-passing direction, and connection portions connecting the crest portions and the trough portions. In the heat exchange core section, a plurality of tube sets each composed of two refrigerant flow tubes spaced from each other in the air-passing direction are disposed at predetermined intervals in the left-right direction. A space is formed between tube sets located adjacent to each other in the left-right direction. At least some of the spaces serve as the air-passing spaces. In each air-passing space, the corrugated fin is disposed to extend over and come into contact with the two refrigerant flow tubes of each of the tube sets located leftward and rightward, respectively, of the air-passing space. The leeward refrigerant flow tubes of all the tube sets form a leeward tube row, and the windward refrigerant flow tubes of all the tube sets form a windward tube row. A core width, which is the straight distance between the leeward edges of the refrigerant flow tubes of the leeward tube row and the windward edges of the refrigerant flow tubes of the windward tube row, is uniform over the entire region in the left-right direction. The widths of all the air-passing spaces in the left-right direction are equal to one another, tube heights of all the refrigerant flow tubes, which are the dimensions of all the refrigerant flow tubes in the thickness direction are equal to one another, and fin heights of all the corrugated fins, which are the dimensions of all the corrugated fins in the left-right direction, are equal to one another. The above-mentioned tube height of the refrigerant flow tubes is 0.75 to 1.5 mm.

Such an evaporator constitutes a refrigeration cycle in combination with a compressor, a condenser (refrigerant cooler) for cooling refrigerant discharged from the compressor, and an expansion valve (pressure-reducing unit) for reducing the pressure of the refrigerant having passed through the condenser. The evaporator is disposed in a casing which has an air introduction opening to which a discharge opening of a blower is connected, an air blowing opening through which air is blown into a vehicle compartment, and an air flow passage through which the air introduction opening and the air blowing opening communicate with each other. A temperature adjustment section for adjusting the temperature of air fed into the air flow passage is disposed in the casing, and the evaporator is disposed in the temperature adjustment section. When the blower is operated, the air whose temperature has been adjusted at the temperature adjustment section is blown into the vehicle compartment through the air blowing opening.

Incidentally, in recent years, a decrease in the size of the casing of a vehicular air conditioner has been demanded for the purpose of securing a larger space within the compartment of an automobile. One measure for reducing the size of the casing is to reduce the above-mentioned core width, which is the dimension of the heat exchange core section of an evaporator used therein, as measured in the air-passing direction.

However, in the case where the core width of the evaporator disclosed in the above-mentioned patent is reduced, and the evaporator having a reduced core width is disposed in the temperature adjustment section of the casing of the vehicular air conditioner, air-passing resistance decreases due to the reduced core width of the evaporator, and the flow speed of air having passed through the evaporator may become uniform in the direction in which the refrigerant flow tubes are arranged (the longitudinal direction of the header tanks).

### SUMMARY OF THE INVENTION

An object of the present invention is to solve the above-described problem and to provide an evaporator which enhances a rectifying effect of refrigerant flow tubes, while minimizing an increase in air-passing resistance, to thereby render the flow speed of air having passed through the evaporator uniform in the direction in which the refrigerant flow tubes are arranged (hereinafter referred to as the “arrangement direction of the refrigerant flow tubes”).

An evaporator according to the present invention includes a heat exchange core section which includes a plurality of flat refrigerant flow tubes whose longitudinal direction coincides with a vertical direction, whose width direction coincides with an air-passing direction; and corrugated fins each of which has crest portions extending in the air-passing direction, trough portions extending in the air-passing direction, and connection portions connecting the crest portions and the trough portions. In the heat exchange core section, a plurality of tube sets each composed of two refrigerant flow tubes spaced from each other in the air-passing direction are disposed at predetermined intervals in a left-right direction; spaces are formed such that each space is formed between tube sets located adjacent to each other in the left-right direction; at least some of the spaces serve as the air-passing spaces; and the corrugated fin is disposed in each air-passing space to extend over and come into contact with the two refrigerant flow tubes of each of the tube sets located leftward and rightward, respectively, of the air-passing space. The leeward refrigerant flow tubes of all the tube sets form a leeward tube row, and the windward refrigerant flow tubes of all the tube sets form a windward tube row; and a core width, which is a straight distance between leeward edges of the refrigerant flow tubes of the leeward tube row and windward edges of the refrigerant flow tubes of the windward tube row, is uniform over an entire region in the left-right direction. Widths of all the air-passing spaces in the left-right direction are equal to one another, tube heights of all the refrigerant flow tubes, which are dimensions of all the refrigerant flow tubes in a thickness direction, are equal to one another, and fin heights of the all the corrugated fins, which are dimensions of all the corrugated fins in the left-right direction, are equal to one another. When the core width is represented by W, a tube pitch, which is a distance between thicknesswise centers of the refrigerant flow tubes located on the left and right sides, respectively, of each air-passing space, is presented by Tp, the tube height is represented by Ht, and the fin height is represented by Hf, W=27 to 32 mm, Tp=4.3 to 5.5 mm, Ht=1.3 to 1.5 mm, Hf=3.0 to 4.0 mm, and Ht/Hf=0.325 to 0.500.

A vehicular air conditioner according to the present invention comprises a casing having an air introduction opening, an air blowing opening, and an air flow passage for establishing communication between the air introduction opening and the air blowing opening; and an evaporator disposed in the air flow passage of the casing and constituting a refrigeration cycle. The air flow passage of the casing has a first portion whose upstream end communicates with the air introduction opening, a second portion in which air flows in a direction intersecting, with a predetermined angle, an air flow direction in the first portion and whose downstream end communicates with the air blowing opening, and a communication portion which establish communication between the first portion and the second portion and changes the flow direction of the air having flowed through the first portion such that the air flows into the second portion. The evaporator is composed of the above-described evaporator of the present invention, the width direction of the refrigerant flow tubes of the evaporator are parallel to an air flow direction in the second portion, and the air-passing spaces of the evaporator allow the air to pass through the evaporator in a direction parallel to the air flow direction in the second portion.

### BRIEF DESCRIPTION OF THE DRAWINGS

FIG. 1 is a partially omitted perspective view showing the overall structure of an embodiment of the evaporator according to the present invention;

FIG. 2 is an enlarged sectional view taken along line A-A of FIG. 1;

FIG. 3 is a horizontal sectional view showing a state in which the evaporator of FIG. 1 is disposed in a casing of a vehicular air conditioner; and

FIG. 4 is a view corresponding to FIG. 3 and showing another embodiment of the evaporator according to the present invention.

### DESCRIPTION OF THE PREFERRED EMBODIMENTS

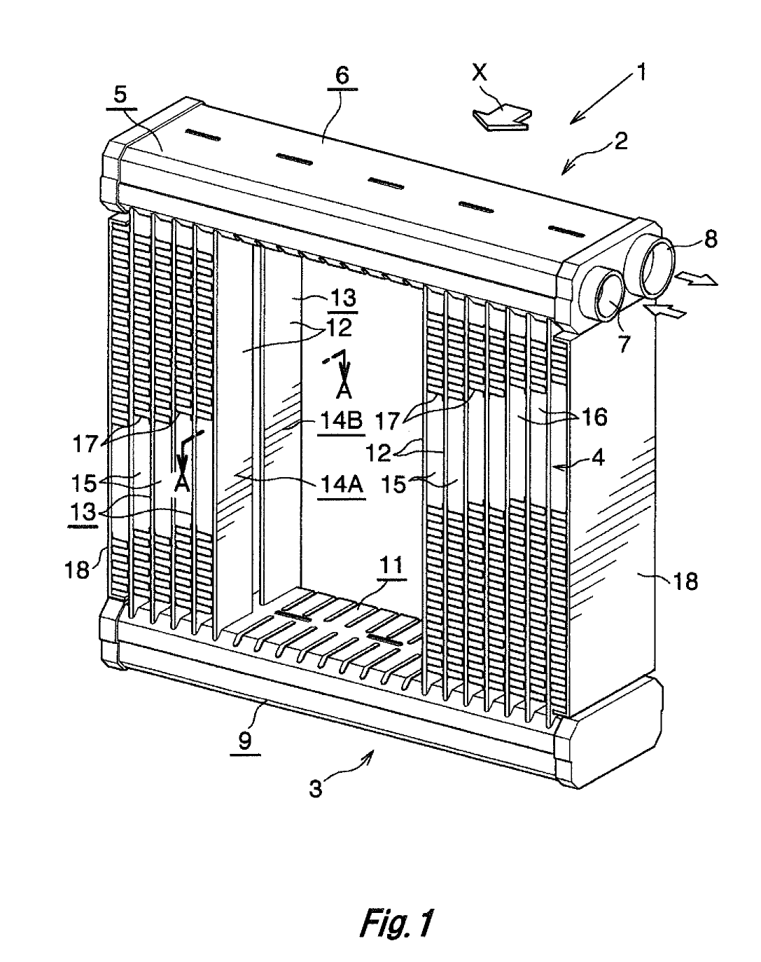

Embodiments of the evaporator according to the present invention will next be described with reference to the drawings. In the embodiments of the evaporator, air flows in a direction indicated by an arrow X in FIG. 1.

In the following description, the term “aluminum” encompasses aluminum alloys in addition to pure aluminum.

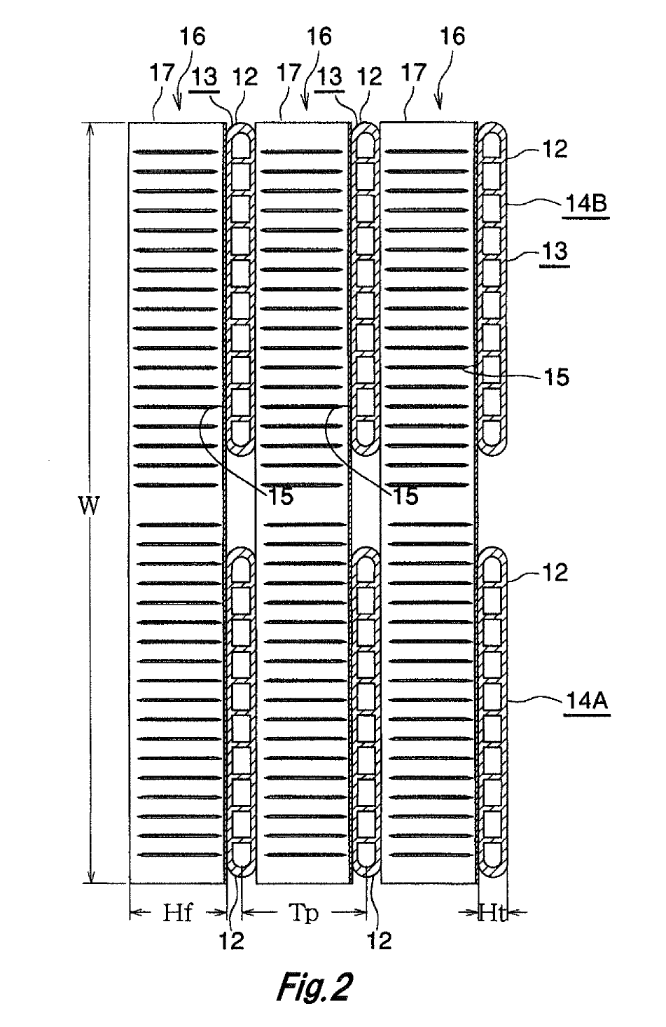

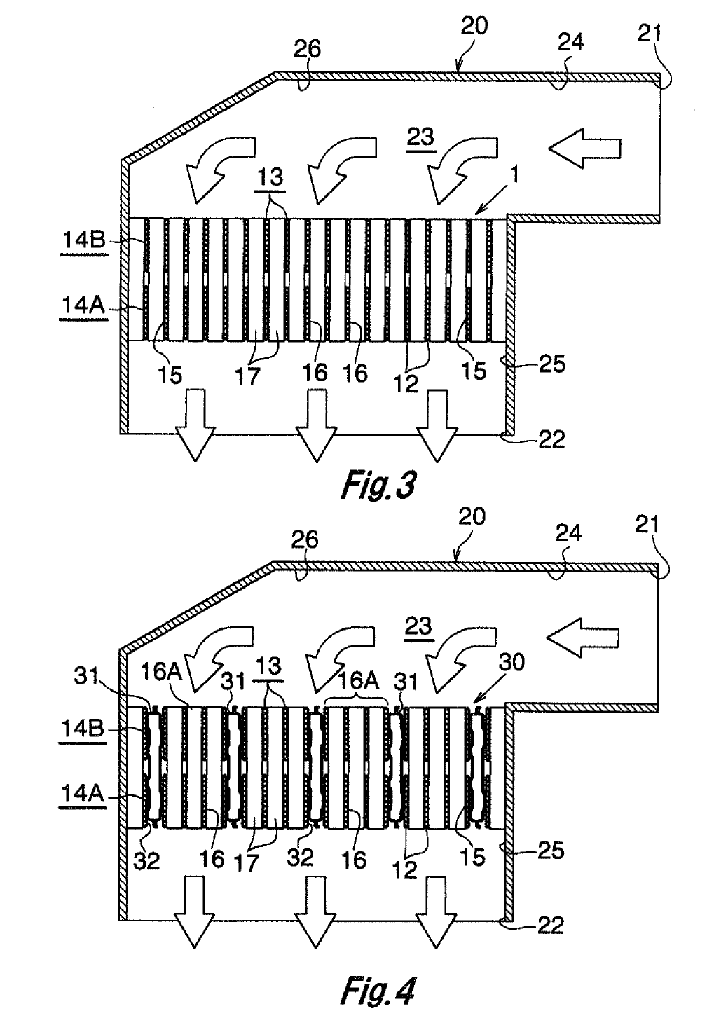

FIG. 1 shows the overall configuration of an evaporator, and FIG. 2 shows the configuration of an essential portion of the evaporator of FIG. 1. FIG. 3 shows the state of use of the evaporator.

As shown in FIG. 1, the evaporator denoted by reference numeral 1 includes an upper header tank 2 and a lower header tank 3, which are formed of aluminum, and a heat exchange core section 4 provided between the two header tanks 2 and 3. The upper header tank 2 and the lower header tank 3 are disposed apart from each in the vertical direction such that their longitudinal direction coincides with the left-right direction and their width direction coincides with the front-rear direction (air-passing direction).

The upper header tank 2 includes a leeward upper header 5 disposed on the front side (the downstream side in the air-passing direction) such that their longitudinal direction coincides with the left-right direction; and a windward upper header 6 disposed on the rear side such that their longitudinal direction coincides with the left-right direction. A refrigerant inlet 7 is provided at the right end of the leeward upper header 5, and a refrigerant outlet 8 is provided at the right end of the windward upper header 6. The lower header tank 3 includes a leeward lower header 9 disposed on the front side such that their longitudinal direction coincides with the left-right direction; and a windward lower header 11 disposed on the rear side such that their longitudinal direction coincides with the left-right direction.

In the heat exchange core section 4, a plurality of tube sets 13 each composed of a plurality (two in the present embodiment) of aluminum flat refrigerant flow tubes 12 are disposed at predetermined intervals in the left-right direction. The refrigerant flow tubes 12 of each tube set 13 are disposed apart from each other in the air-passing direction such that their longitudinal direction coincides with the vertical direction and their width direction coincides with the air-passing direction. As a result, a space 15 is formed between two tube sets 13 each of which is composed of two refrigerant flow tubes 12 arranged in the air-passing direction and which are located adjacent to each other. The leeward refrigerant flow tubes 12 of all the tube sets 13 form a leeward tube row 14A, and the windward refrigerant flow tubes 12 of all the tube sets 13 form a windward tube row 14B. Upper end portions of the refrigerant flow tubes 12 of the leeward tube row 14A are connected to the leeward upper header 5, and lower end portions of the refrigerant flow tubes 12 of the leeward tube row 14A are connected to the leeward lower header 9. Upper end portions of the refrigerant flow tubes 12 of the windward tube row 14B are connected to the windward upper header 6, and lower end portions of the refrigerant flow tubes 12 of the windward tube row 14B are connected to the windward lower header 11.

All the spaces 15 of the heat exchange core section 4 serve as air-passing spaces 16. Corrugated fins 17 formed of an aluminum brazing sheet having a brazing material layer on each of opposite sides thereof are provided in all the air-passing spaces 16. Each of the corrugated fins 17 has crest portions extending in the air-passing direction, trough portions extending in the air-passing direction, and connection portions connecting the crest portions and the trough portions. Specifically, each corrugated fin 17 is disposed in the corresponding air-passing space 16 to extend over the windward and leeward refrigerant flow tubes 12 of the corresponding tube sets 13 and is joined to the windward and leeward refrigerant flow tubes 12 through use of a brazing material. In the following description, an operation of joining members through use of a brazing material will be called brazing. Also, on the outer side of the tube sets 13 at the left and right ends, corrugated fins 17 are disposed to extend over the windward and leeward refrigerant flow tubes 12 of the corresponding tube sets 13 and are brazed to the windward and leeward refrigerant flow tubes 12. Further, aluminum side plates 18 are disposed on the outer side of the corrugated fins 17 at the left and right ends and are brazed to these corrugated fins 17.

A core width, which is a straight distance between the leeward edges of the refrigerant flow tubes 12 of the leeward tube row 14A and the windward edges of the refrigerant flow tubes 12 of the windward tube row 14B in the evaporator 1, is uniform over the entire region in the left-right direction. The widths of all the air-passing spaces 16 in the left-right direction are equal to one another. The tube heights of all the refrigerant flow tubes 12, which are the dimensions of all the refrigerant flow tubes 12 in the thickness direction are equal to one another. The fin heights of all the corrugated fins 17, which are the dimensions of all the corrugated fins 17 in the left-right direction, are equal to one another.

The above-mentioned core width is represented by W; a tube pitch, which is the distance between the thicknesswise centers of the refrigerant flow tubes 12 located on the left and right sides, respectively, of each air-passing space 16, is presented by Tp; the above-mentioned tube height is represented by Ht; and the above-mentioned fin height is represented by Hf. The evaporator 1 is configured to satisfy the conditions that W=27 to 32 mm, Tp=4.3 to 5.5 mm, Ht=1.3 to 1.5 mm, Hf=3.0 to 4.0 mm, and Ht/Hf=0.325 to 0.500. Preferably, the evaporator 1 is configured to satisfy the conditions that W=27 to 30 mm, Tp=4.3 to 5.2 mm, Ht=1.3 to 1.4 mm, Hf=3.0 to 3.8 mm, and Ht/Hf=0.325 to 0.467.

The above-described evaporator 1 constitutes a refrigeration cycle in combination with a compressor, a condenser (refrigerant cooler) for cooling refrigerant discharged from the compressor, and an expansion valve (pressure-reducing unit) for reducing the pressure of the refrigerant having passed through the condenser. As shown in FIG. 3, the evaporator 1 is disposed in a casing 20 which has an air introduction opening 21 to which a discharge opening of a blower (not shown) is connected, an air blowing opening 22 through which air is blown into a vehicle compartment, and an air flow passage 23 through which the air introduction opening 21 and the air blowing opening 22 communicate with each other. The air flow passage 23 of the casing 20 has a first portion 24, a second portion 25, and a communication portion 26. An upstream end of the first portion 24 communicates with the air introduction opening 21. In the second portion 25, air flows in a direction orthogonal to an air flow direction in the first portion 24. A downstream end of the second portion 25 communicates with the air blowing opening 22. The communication portion 26 is provided at a position where an extension from the first portion 24 toward the downstream side with respect to the air flow direction in the first portion intersects with an extension from the second portion 25 toward the upstream side with respect to an air flow direction in the second portion. The communication portion 26 establishes communication between the first portion 24 and the second portion 25 and changes the flow direction of the air having flowed through the first portion 24 such that the air flows into the second portion 25. The evaporator 1 is disposed in an upstream portion of the second portion 25 of the air flow passage 23, and the air-passing spaces 16 of the evaporator 1 allow the air to pass through the evaporator 1 in a direction parallel to the air flow direction in the second portion 25.

Although not illustrated, a temperature control section is provided in the casing 20. The temperature control section includes the evaporator 1; a heater core disposed in the casing 20 to be located downstream of the evaporator 1 with respect to the air flow direction; and an air mixing damper for adjusting the ratio between the amount of air which is fed to the heater core after passing through the evaporator 1 and the amount of air which is caused to detour around the heater core after passing through the evaporator 1.

In the case where, the core width W, the tube pitch Tp, the tube height Ht, and the fin height Hf of the evaporator 1 satisfy the above-described conditions, when the vehicular air conditioner is operated, the refrigerant flow tubes 12 serve as a guide for the air passing through the air-passing spaces 16. As a result, a rectifying effect is obtained. Accordingly, even in the case where the core width W is rendered relatively small to satisfy the condition of W=27 to 32 mm, the flow speed of the air having passed through the evaporator 1 is rendered uniform in the arrangement direction of the refrigerant flow tubes 12 (in the left-right direction). In addition, an increase in air-passing resistance can be suppressed in the case where the dimension of the heat exchange core section 4 of the evaporator 1 in the arrangement direction of the refrigerant flow tubes 12 is equal to that of the conventional evaporator.

FIG. 4 shows another embodiment of the evaporator according to the present invention.

In the case of an evaporator 30 shown in FIG. 4, some of all the spaces 15 in the heat exchange core section 4 serves as the air-passing spaces 16, and the remaining spaces 15 serve as container disposing spaces 32 in which cool storing material containers 31 formed of aluminum and containing a cool storing material are disposed. Each of the cool storing material containers 31 is disposed to extend over the windward and leeward refrigerant flow tubes 12 of the corresponding tube sets 13 and is brazed to the windward and leeward refrigerant flow tubes 12.

A plurality of air-passing space groups 16A each composed of two or more (three in the present embodiment) air-passing spaces 16 continuously arranged in the left-right direction are provided such that the air-passing space groups 16A are spaced from one another in the left-right direction. One container disposing space 32 is provided between two air-passing space groups 16A located adjacent to each other in the left-right direction. Notably, the number of the air-passing spaces 16 constituting each air-passing space group 16A is preferably 2 to 7.

The present invention comprises the following modes.

1) An evaporator including a heat exchange core section which includes a plurality of flat refrigerant flow tubes whose longitudinal direction coincides with a vertical direction, whose width direction coincides with an air-passing direction; and corrugated fins each of which has crest portions extending in the air-passing direction, trough portions extending in the air-passing direction, and connection portions connecting the crest portions and the trough portions,

wherein in the heat exchange core section, a plurality of tube sets each composed of two refrigerant flow tubes spaced from each other in the air-passing direction are disposed at predetermined intervals in a left-right direction; spaces are formed such that each space is formed between tube sets located adjacent to each other in the left-right direction; at least some of the spaces serve as the air-passing spaces; the corrugated fin is disposed in each air-passing space to extend over and come into contact with the two refrigerant flow tubes of each of the tube sets located leftward and rightward, respectively, of the air-passing space; the leeward refrigerant flow tubes of all the tube sets form a leeward tube row, and the windward refrigerant flow tubes of all the tube sets form a windward tube row; a core width, which is a straight distance between leeward edges of the refrigerant flow tubes of the leeward tube row and windward edges of the refrigerant flow tubes of the windward tube row, is uniform over an entire region in the left-right direction; and widths of all the air-passing spaces in the left-right direction are equal to one another, tube heights of all the refrigerant flow tubes, which are dimensions of all the refrigerant flow tubes in a thickness direction, are equal to one another, and fin heights of the all the corrugated fins, which are dimensions of all the corrugated fins in the left-right direction, are equal to one another,

wherein when the core width is represented by W, a tube pitch, which is a distance between thicknesswise centers of the refrigerant flow tubes located on the left and right sides, respectively, of each air-passing space, is presented by Tp, the tube height is represented by Ht, and the fin height is represented by Hf, W=27 to 32 mm, Tp=4.3 to 5.5 mm, Ht=1.3 to 1.5 mm, Hf=3.0 to 4.0 mm, and Ht/Hf=0.325 to 0.500.

2) An evaporator described in par. 1), wherein W=27 to 30 mm, Tp=4.3 to 5.2 mm, Ht=1.3 to 1.4 mm, Hf=3.0 to 3.8 mm, and Ht/Hf=0.325 to 0.467.

3) An evaporator described in par. 1) or 2), wherein all the spaces each formed between tube sets located adjacent to each other in the left-right direction serve as the air-passing spaces.

4) An evaporator described in par. 1) or 2), wherein some of all the spaces each formed between tube sets located adjacent to each other in the left-right direction serve as the air-passing spaces; the remaining spaces serve as container disposing spaces in each of which a cool storing material container containing a cool storing material is disposed; a plurality of air-passing space groups each composed of two or more air-passing spaces continuously arranged in the left-right direction are provided such that the air-passing space groups are spaced from one another in the left-right direction; and one container disposing space is provided between two air-passing space groups located adjacent to each other in the left-right direction.

5) A vehicular air conditioner comprising: a casing having an air introduction opening, an air blowing opening, and an air flow passage for establishing communication between the air introduction opening and the air blowing opening; and an evaporator disposed in the air flow passage of the casing and constituting a refrigeration cycle, the air flow passage of the casing having a first portion whose upstream end communicates with the air introduction opening, a second portion in which air flows in a direction intersecting, with a predetermined angle, an air flow direction in the first portion and whose downstream end communicates with the air blowing opening, and a communication portion which establish communication between the first portion and the second portion and changes the flow direction of the air having flowed through the first portion such that the air flows into the second portion,

wherein the evaporator is composed of the evaporator described in any of pars. 1) to 4), the width direction of the refrigerant flow tubes of the evaporator are parallel to an air flow direction in the second portion, and the air-passing spaces of the evaporator allow the air to pass through the evaporator in a direction parallel to the air flow direction in the second portion.

6) A vehicular air conditioner described in par. 5), wherein the communication portion of the air flow passage of the casing is provided at an intersection between an extension from the first portion toward a downstream side with respect to the air flow direction in the first portion and an extension from the second portion toward an upstream side with respect to the air flow direction in the second portion, and the second portion of the air flow passage of the casing causes the air to flow in a direction orthogonal to the air flow direction in the first portion.

In the evaporators of pars. 1) to 4), when the core width is represented by W, the tube pitch, which is a distance between thicknesswise centers of the refrigerant flow tubes located on the left and right sides, respectively, of each air-passing space, is presented by Tp, the tube height is represented by Ht, and the fin height is represented by Hf, the conditions that Tp=4.3 to 5.5 mm, Ht=1.3 to 1.5 mm, Hf=3.0 to 4.0 mm, and Ht/Hf=0.325 to 0.500 are satisfied. Therefore, the refrigerant flow tubes serve as a guide for the air passing through the air-passing spaces, whereby a rectifying effect is obtained. Accordingly, even in the case where the core width W is rendered relatively small to satisfy the condition of W=27 to 32 mm, the flow speed of the air having passed through the evaporator is rendered uniform in the arrangement direction of the refrigerant flow tubes (the left-right direction). In addition, an increase in air-passing resistance can be suppressed in the case where the dimension of the heat exchange core section of the evaporator in the arrangement direction of the refrigerant flow tubes (the left-right direction) is equal to that of the conventional evaporator.

In the evaporator of par. 2), the rectifying effect obtained as a result of the refrigerant flow tubes functioning as a guide is enhanced further.

In the vehicular air conditioners of pars. 5) and 6), the flow speed of air blown into a vehicle compartment is rendered uniform in the arrangement direction of the refrigerant flow tubes of the evaporator.

What is claimed is:

1. An evaporator including a heat exchange core section which includes a plurality of flat refrigerant flow tubes whose longitudinal direction coincides with a vertical direction, whose width direction coincides with an air-passing direction; and corrugated fins each of which has crest portions extending in the air-passing direction, trough portions extending in the air-passing direction, and connection portions connecting the crest portions and the trough portions,
wherein in the heat exchange core section, a plurality of tube sets each composed of two refrigerant flow tubes spaced from each other in the air-passing direction are disposed at predetermined intervals in a left-right direction; spaces are formed such that each space is formed between tube sets located adjacent to each other in the left-right direction; at least some of the spaces serve as the air-passing spaces; the corrugated fin is disposed in each air-passing space to extend over and come into contact with the two refrigerant flow tubes of each of the tube sets located leftward and rightward, respectively, of the air-passing space; the leeward refrigerant flow tubes of all the tube sets form a leeward tube row, and the windward refrigerant flow tubes of all the tube sets form a windward tube row; tube heights of all the refrigerant flow tubes, which are dimensions of all the refrigerant flow tubes in a thickness direction, are equal to one another, and fin heights of the all the corrugated fins, which are dimensions of all the corrugated fins in the left-right direction, are equal to one another,
wherein when the core width is represented by W, a tube pitch, which is a distance between thicknesswise centers of the refrigerant flow tubes located on the left and right sides, respectively, of each air-passing space, is presented by Tp, the tube height is represented by Ht, and the fin height is represented by Hf, W=27 to 32 mm, Tp=4.3 to 5.5 mm, Ht=1.3 to 1.5 mm, Hf=3.0 to 4.0 mm, and Ht/Hf=0.325 to 0.500.

2. The evaporator according to claim 1, wherein W=27 to 30 mm, Tp=4.3 to 5.2 mm, Ht=1.3 to 1.4 mm, Hf=3.0 to 3.8 mm, and Ht/Hf=0.325 to 0.467.

3. The evaporator according to claim 1, wherein all the spaces each formed between tube sets located adjacent to each other in the left-right direction serve as the air-passing spaces.

4. The evaporator according to claim 1, wherein
some of all the spaces each formed between tube sets located adjacent to each other in the left-right direction serve as the air-passing spaces;
the remaining spaces serve as container disposing spaces in each of which a cool storing material container containing a cool storing material is disposed;
a plurality of air-passing space groups each composed of two or more air-passing spaces continuously arranged in the left-right direction are provided such that the air-passing space groups are spaced from one another in the left-right direction; and
one container disposing space is provided between two air-passing space groups located adjacent to each other in the left-right direction.
